(19) United States
(12) Patent Application Publication
(10) Pub. No.: US 2010/0285200 A1
(43) Pub. Date: Nov. 11, 2010

(54) High-Protein Beverages and Methods of Manufacture

(75) Inventor: Eric A. Garonzik, Mechanicsburg, PA (US)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: Multi Protein Incorporated, Camp Hill, PA (US)

(21) Appl. No.: 12/828,616

(22) Filed: Jul. 1, 2010

Related U.S. Application Data
(63) Continuation of application No. 12/692,166, filed on Jan. 22, 2010.
(60) Provisional application No. 61/205,663, filed on Jan. 22, 2009.
(60) Provisional application No. 61/205,664, filed on Jan. 22, 2009.
(60) Provisional application No. 61/205,666, filed on Jan. 22, 2009.
(60) Provisional application No. 61/222,548, filed on Jul. 2, 2009.

(51) Int. Cl. A23L 2/52; A23L 2/00; C12C 12/00; A23F 3/00; A23L 2/02; A23C 21/00

(52) U.S. Cl. 426/592; 426/590; 426/597; 426/599; 426/506

(57) ABSTRACT

High-protein beverages are manufactured by infusion of hydrated whey protein into an acidic beverage prior to packaging. The protein content of such beverages makes them more compatible with the dietary restrictions of persons with diabetes mellitus, for example.

### RELATED APPLICATIONS

Applicant hereby claims priority to the previously filed U.S. provisional application having a filing date of Jul. 2, 2009, and Ser. No. 61/222,548.

### FIELD

This application describes high-protein beverages suitable for consumption by persons with diabetes mellitus, as well as methods of manufacture thereof.

### BACKGROUND

Diabetes mellitus, often simply referred to simply as diabetes, is a syndrome of disordered carbohydrate metabolism, usually due to a combination of hereditary and environmental causes, resulting in hyperglycemia. Diabetes develops due to a diminished production of insulin (in type 1) or resistance to its effects (in type 2), both of which lead to increased amounts of blood glucose, which are responsible for the acute and chronic symptoms of diabetes. All forms of diabetes may be treatable with a variety of medicines, including injectable insulin and insulin sensitizers, but there is no cure. Persons with diabetes manage their disease with a combination of physical exercise, medical intervention, and dietary restrictions.

The diet most often recommended for people who have diabetes is typically high in dietary fiber, especially soluble fiber, and low in fat especially saturated fats. Patients may be encouraged to reduce their intake of carbohydrates that have a high glycemic index, such as foods high in simple sugars (glucose and sucrose), complex sugars (starches), and sugar alcohols (ethanol).

### SUMMARY

Proteins may be consumed with such foods in order to mitigate the diabetic glucose-insulin spike and crash. Accordingly, the invention provides high-protein beverages suitable for consumption by diabetic persons in conjunction with a dietary regimen within sound medical judgment. A high-protein beverage product according to an embodiment hereof includes micronized, hydrolyzed cow's milk whey protein. Additional features may be understood by referring to the accompanying drawings, which should be read in conjunction with the following detailed description and examples.

### DETAILED DESCRIPTION

The novel high-protein beverage products described herein include micronized, hydrolyzed cow's milk whey protein. Whey is the liquid remaining after cow's milk has been curdled and strained, and it is a by-product of the manufacture of cheese. Whey protein is the name for a collection of globular proteins that can be isolated from whey. It is typically a mixture of alpha- and beta-lactoglobulin, as well as albumin. Whey protein has a very high bioavailability, which refers to how quickly a substance will be digested and absorbed through the small intestine and thus into the blood stream. Of particular importance to the present invention, research suggests that whey stimulates insulin release, and whey can help regulate and reduce spikes in blood sugar levels among people with type 2 diabetes by increasing insulin secretion. See, e.g., “Effect of whey on blood glucose and insulin responses to composite breakfast and lunch meals in type 2 diabetic subjects” by Frid et al., Am. J. Clin. Nutrition 82, 69-75 (2005).

While in principle the invention may include the use of other proteins, such as milk solids or soy protein, whey protein is preferred. Milk solids, for example, may include butter fats and milk sugars, such as lactose, to which many persons are sensitive. Milk solids may also impart an undesirable taste or mouth feel to non-dairy beverages. Likewise, soy proteins may include phytoestrogens, which are non-steroidal plant compounds that, because of their structural similarity with estradiol, have the ability to cause undesirable estrogenic hormonal effects. For these reasons, among others, whey protein is preferred.

Whey protein is commercially available from a variety of vendors. Preferably, the whey protein is provided as a dry micronized powder, having an average particle size of about 180 microns. A high-protein beverage product may be made by first hydrating the micronized, hydrolyzed cow's milk whey protein with water, and thereafter infusing the mixture (that is, slowing mixing the higher concentration mixture into the lower concentration mixing vessel) of water and micronized, hydrolyzed cow's milk whey protein into a beverage, wherein the ratio of admixed pre-hydration water to protein is about 1 mL water to about 1 g protein. Simply mixing the dry whey powder into the beverage typically results in foaming, protein coagulation, incomplete mixing, and other undesirable manufacturing difficulties. Accordingly, it is preferable to hydrate the whey protein powder over at least about 30 minutes, and to infuse the resulting slurry into the beverage over at least about 5 minutes while mixing the beverage-protein mixture.

Preferred beverage products are “all natural,” and include only ingredients isolated from or directly obtained from nature. In the case of fermented products, such as beer, “all natural” includes fermentation products of ingredients isolated from nature or directly obtained from nature. Beverage products are therefore preferably free of synthetic emulsifiers and synthetic preservatives (e.g., ethylenediamine tetraacetate (EDTA), butyrated hydroxytoluene (BHT), potassium benzoate).

Example beverage products include juice beverages. The fruit juice can be any citrus juice, non-citrus juice, or mixture thereof. The juice can be derived from apple, cranberry, pear, peach, plum, apricot, nectarine, grape, cherry, currant, raspberry, gooseberry, elderberry, blackberry, blueberry, strawberry, lemon, lime, mandarin, orange, grapefruit, cupuacu, potato, tomato, lettuce, celery, spinach, cabbage, watercress, dandelion, rhubarb, carrot, beet, cucumber, pineapple, coconut, pomegranate, kiwi, mango, papaya, banana, watermelon, tangerine, and cantaloupe, among others.

Beverage products may also include teas, such as brewed teas containing tea solids extracted from tea materials including those materials obtained from the genus Camellia, including C. sinensis and C. assaimica, for instance, freshly gathered tea leaves, fresh green tea leaves that are dried immediately after gathering, fresh green tea leaves that have been heat treated before drying to inactivate any enzymes present, unfermented tea, instant green tea and partially fermented tea leaves. Green tea materials are tea leaves, tea plant stems and other plant materials that are related and which have not undergone substantial fermentation to create black teas. Mixtures of unfermented and partially fermented teas may also be used. Tea solids typically also include caffeine, theobromine, proteins, amino acids, minerals and carbohydrates. So-called “herbal teas”, which usually refer to an infusion or tisane of leaves, flowers, fruit, herbs or other plant material (e.g., mint, cinnamon, cardamom, citrus), may also be used.

Further examples of beverage products include fermented beverages, such as beer, malt liquor, and wine. The basic ingredients of beer are water; a starch source, such as malted barley, able to be fermented (converted into alcohol); a brewer's yeast to produce the fermentation; and a flavoring such as hops. A mixture of starch sources may be used, with a secondary starch source, such as corn, rice or sugar, often being termed an adjunct, especially when used as a lower-cost substitute for malted barley. Less widely used starch sources include millet, sorghum and cassava. Wine is another alcoholic beverage typically made of fermented grape juice. Wine is typically produced by fermenting crushed grapes or another fruit using various types of yeast. Although other fruits such as apples and berries can also be fermented. Others, such as barley wine and rice wine (i.e., sake), are made from starch-based materials and resemble beer and spirit more than wine, while ginger wine is fortified with brandy. In these cases, the use of the term “wine” is a reference to the higher alcohol content, rather than production process. In any case, such fermented alcoholic beverages may include whey protein as described herein. Malt liquor is a generic term referring to a variety of non-distilled alcoholic beverages, including high alcohol beers and alcoholic cocktail beverages (e.g., hard lemonade and iced tea), which may be fortified with distilled spirits.

The pH of the beverage product may be adjusted to facilitate incorporation of the whey protein into the liquid phase. Whey protein is more soluble at lower pH, and adding an acid to the beverage product may help to solubilize the protein. The particular pH should be within a range that produces a pleasing taste profile and is palatable. In some cases, it is acceptable for the protein to be suspended in solution, the resulting beverage product having a semi-opaque or turbid appearance, sometimes referred to as a haze. In such cases, when the pH is lowered upon serving (e.g., by squeezing citrus, such as a lemon, orange, or lime into the beverage) the haze is at least partially mitigated. A typical pH range is between about 2.9 and about 3.6.

By way of example, when the beverage product is an alcoholic beer, the pH may be below about 3.8, for example, between about 2.9 and about 3.2. Such a beer includes hops, water, added whey protein, and a carbohydrate, or a fermentation product thereof, the source, type, and character of the ingredients being selected to produce a product having suitable pH. Whey protein is added to the fermented beer prior to bottling so that the beverage product includes at least about 7 g of said whey protein per 12 oz (354 mL), in addition to about 1 g of protein naturally resulting from the brewing process.

By way of further example, when the beverage product is a tea having, the a pH may be between about 2.9 and about 3.4, the tea including water, brewed tea extract, a nutritive (e.g., sucrose, glucose, fructose) or non-nutritive (e.g., sucralose, aspartame, stevia) sweetener, and whey protein. The tea beverage product may also include a food-grade acid (e.g., phosphoric acid, citric acid). Whey protein is added to the tea so that the beverage product includes at least about 10 g of whey protein per 16 oz (473 mL).

A variety of other beverages are within the purview of this invention. For example, the protein-enhanced beverage may be an energy drink, which is typically a lightly carbonated drink that provides energy to improve physical activity of the drinker, as compared to a typical drink. Rather than providing food energy as measured in calories, these drinks are designed to increase a user's mental alertness and physical performance by the addition of caffeine, vitamins, and herbal supplements that may interact to provide a stimulant effect over and above that obtained from caffeine alone.

Energy drinks are sometimes mixed with alcohol. While energy drinks are stimulants, alcohol is a depressant. Normally, fatigue would set in as alcohol is consumed, but the stimulating effect of energy drinks can override this effect. Often consumed with vodka or in shots, it has led to an increase in the purchase of pre-mixed drinks also known as alco-pops often containing guarana or taurine extract, which provides energy drinks with their flavor.

Protein-enhanced beverages also include creamers. Creamers, generally non-dairy based, are liquid or granular substances intended to substitute for milk or cream as an additive to coffee or other beverages. Because they typically do not contain lactose, they are therefore not considered dairy products; accordingly, some parts of the world require the alternate term non-dairy whiteners that do not imply the presence of real cream. Generally these are added to hot drinks for proper dissolution.

Coffee is yet another exemplary beverage. Coffee is a brewed beverage prepared from roasted seeds, commonly called coffee beans, of the coffee plant. Due to its caffeine content, coffee has a stimulating effect in humans. Coffee can be served hot or cold. So called “ready to drink” coffee or an “RTD” coffee requires no preparation and comes already brewed in a container that may contain other ingredients to enhance flavor or provide an energy-boosting effect.

Sports drink may also be enhanced with whey protein. A sports drink is a beverage designed to help athletes rehydrate, as well as replenish electrolytes, carbohydrates, and other nutrients, which can be depleted after training or competition. Electrolyte replacement promotes proper rehydration, which is important in delaying the onset of fatigue during exercise. As the primary fuel utilized by exercising muscle, carbohydrates are important in maintaining exercise and sport performance.

Yet another exemplary protein-enhanced beverage is a nutritional drink/meal replacement supplement. Such beverages are designed to provide a balanced meal in a liquid form. Vitamins, minerals, a blend of both simple and complex carbohydrates, and other nutrients combine to provide this well-balanced formula. The product is often used by specific populations at risk of malnutrition such as the elderly, ill people, indigents and others. Such product may be water based, soy based, and/or non-milk-based to avoid lactose intolerance and associated bloating observed with currently available famine relief products, and should preferably contain whey protein in sufficient quantity to avoid muscle wasting.

Regardless of the type of beverage, the amount of whey protein added to the beverage product should be sufficient to have a meaningful nutritive or physiological effect, particularly on persons with diabetes. That is, the whey protein is not merely added to improve or otherwise alter the flavor profile of physical characteristics of the beverage. Beverage products may be pasteurized in order to impart shelf-stable at room temperature. Furthermore, the whey protein preferably does not substantially coagulate or precipitate from the beverage product during storage or transportation at room temperature or while refrigerated. Suitable whey protein products may be obtained from Fonterra in Rosemont Ill.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

1. A high-protein beverage product comprising
micronized, hydrolyzed cow's milk whey protein.

2. The beverage product according to claim 1, wherein said whey protein has an average particle size of about 180 microns.

3. The beverage product according to claim 1, wherein said beverage product is free of synthetic preservatives and emulsifiers.

4. The beverage product according to claim 1, wherein said beverage product has a pH between about 2.9 and about 3.6.

5. The beverage product according to claim 1, wherein said beverage product is an alcoholic beverage having a pH between about 2.9 and about 3.2, said beverage comprising water, said whey protein, and a carbohydrate, or a fermentation product thereof.

6. The beverage product according to claim 5, wherein said beverage product is a beer, malt liquor, or wine.

7. The beverage product according to claim 5, wherein said beverage product comprises at least about 7 g of said whey protein per 12 oz (354 mL).

8. The beverage product according to claim 1, wherein said beverage product is a tea beverage having a pH between about 2.9 and about 3.4, said tea beverage comprising water, brewed tea extract, a nutritive or non-nutritive sweetener, and said whey protein.

9. The beverage product according to claim 8, said beverage product further comprising a food-grade acid.

10. The beverage product according to claim 9, wherein said beverage product comprises at least about 10 g of said whey protein per 16 oz (473 mL).

11. The beverage product according to claim 1, wherein said beverage product is pasteurized and shelf-stable at room temperature.

12. The beverage product according to claim 1, wherein said whey protein does not substantially coagulate or precipitate from said beverage product during storage or transportation.

13. The beverage product according to claim 1, wherein said beverage product comprises a fruit juice.

14. A method of manufacturing a high-protein beverage product comprising hydrating micronized, hydrolyzed cow's milk whey protein with water, and thereafter infusing the mixture of water and micronized, hydrolyzed cow's milk whey protein into a beverage, wherein the ratio of admixed pre-hydration water to protein is about 1 mL water to about 1 g protein.

15. The method according to claim 14, wherein said hydrating step is carried out over at least about 30 minutes.

16. The method according to claim 14, wherein said infusing step is carried out over at least about 5 minutes while mixing.
